(19) United States
(12) Patent Application Publication
(10) Pub. No.: US 2014/0086035 A1
(43) Pub. Date: Mar. 27, 2014

(54) LENS DRIVING DEVICE, INFORMATION RECORDING AND PLAYBACK APPARATUS, AND ELECTRONIC INSTRUMENT

(71) Applicant: KABUSHIKI KAISHA TOSHIBA, Tokyo (JP)

(72) Inventors: Yasuaki Hadame, Tokyo (JP); Kazuo Watabe, Yokohama-shi (JP)

(73) Assignee: KABUSHIKI KAISHA TOSHIBA, Tokyo (JP)

(21) Appl. No.: 13/967,572

(22) Filed: Aug. 15, 2013

(30) Foreign Application Priority Data
Sep. 24, 2012 (JP) 2012-210078

(51) Int. Cl. G11B 7/1392

(52) U.S. Cl. CPC G11B 7/13925
USPC 369/112.23

(57) ABSTRACT

According to one embodiment, a lens driving device includes a fixed member, a movable member, a support part, and a coil. The movable member is configured to retain a lens and a magnet. The supporting part is configured such that a guide member placed substantially in parallel with a lens optical axis supports the movable member at plural positions symmetric with respect to the lens optical axis while the movable member is movable in a direction of the lens optical axis with respect to the fixed member. The coil is configured such that a driving force is generated for the movable member by interaction with the magnet provided in the fixed member.

### CROSS-REFERENCE TO RELATED APPLICATIONS

This application is based upon and claims the benefit of priority from Japanese Patent Application No. 2012-210078, filed Sep. 24, 2012, the entire contents of which are incorporated herein by reference.

### FIELD

Embodiments described herein relate generally to a lens driving device, an information recording and playback apparatus, and an electronic instrument.

### BACKGROUND

As is well known, nowadays there is developed what is called a super-multilayer optical disk including at least 10 recording layers. This kind of optical disk includes a structure in which one guide layer is provided for plural recording layers, recording and playback are performed to any recording layer based on the same guide layer.

Specifically, using the same objective lens, a blue laser beam is focused on the desired recording layer while a red laser beam is focused on the guide layer. A position of the objective lens is controlled such that the red laser beam is guided along the guide layer, and the recording and the playback are performed to the desired recording layer using the blue laser beam through the objective lens.

In order that the red laser beam and the blue laser beam are focused on the guide layer and the desired recording layer using the same objective lens, it is necessary to provide two optical paths, namely, a red laser beam optical path and a blue laser beam optical path. The structure becomes more complex, which results in enlargement of the recording and playback instrument.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view illustrating an example of a sectional structure of an optical disk having a super-multilayer structure;

FIG. 2 is a block configuration diagram illustrating an example of a signal processing system of an information recording and playback apparatus according to an embodiment that performs recording and playback to the optical disk;

FIG. 3 is a view illustrating an example of an optical system of an optical pickup head unit used in the information recording and playback apparatus of the embodiment;

FIG. 4 is a view illustrating an example of a recording and playback operation that is performed to the optical disk by the optical pickup head unit of the embodiment;

FIG. 5 is a perspective view illustrating an example of a lens actuator constituting the optical pickup head unit of the embodiment;

FIGS. 6A, 6B, and 6C are views illustrating an example of the lens actuator of the embodiment when the lens actuator is viewed from a front side, an upper side, and a side surface;

FIG. 7 is a characteristic curve illustrating a driving speed of the lens actuator of the embodiment;

FIG. 8 is a perspective view illustrating a modification of the lens actuator of the embodiment; and

FIG. 9 is a block configuration diagram illustrating an example of a mobile information terminal to which the lens actuator of the embodiment is applied.

### DETAILED DESCRIPTION

Various embodiments will be described hereinafter with reference to the accompanying drawings.

In general, according to one embodiment, a lens driving device includes a fixed member, a movable member, a support part, and a coil. The movable member is configured to retain a lens and a magnet. The supporting part is configured such that a guide member placed substantially in parallel with a lens optical axis supports the movable member at plural positions symmetric with respect to the lens optical axis while the movable member is movable in a direction of the lens optical axis with respect to the fixed member. The coil is configured such that a driving force is generated for the movable member by interaction with the magnet provided in the fixed member.

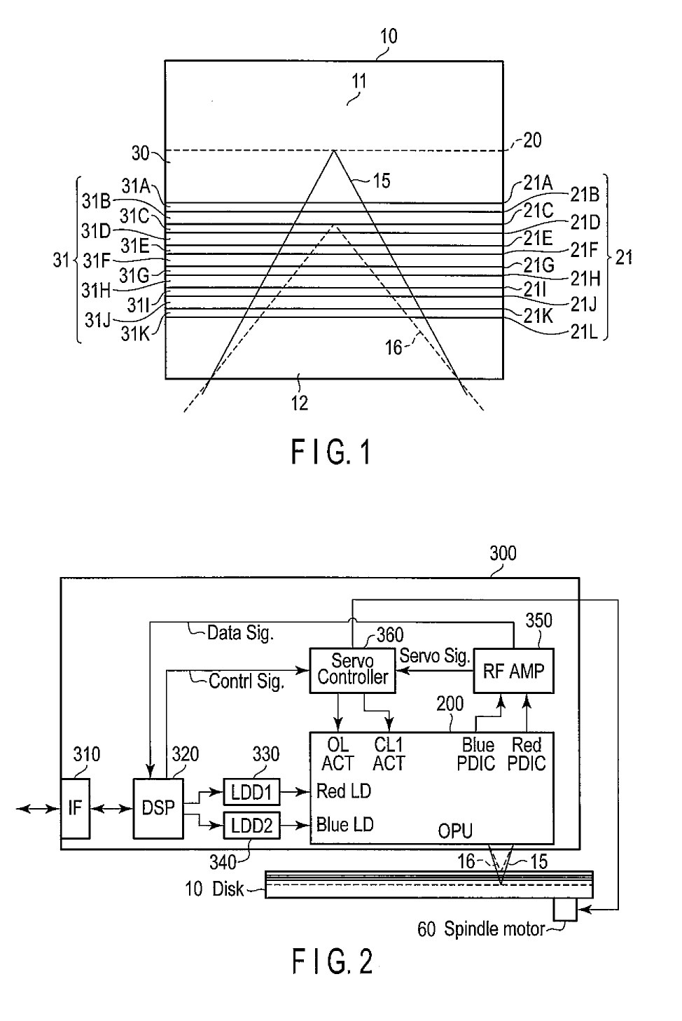

FIG. 1 illustrates a sectional structure of an optical disk 10 in the embodiment. The optical disk 10 includes plural recording and playback layers, and information is recorded in a recording film by a laser beam emitted from an optical pickup (OPU). For example, an upper surface shape of the optical disk 10 is a circle having a diameter of 120 mm.

The optical disk 10 includes a structure in which a guide layer 20 and a recording layer 21 (including recording layers 21A to 21L) are formed on a substrate 11. In the guide layer 20, a guide groove or a pit string is formed in order to generate a servo signal during recording and playback. The recording layer 21 is also called a recording layer group, and the recording layer group includes 12 recording layers 21A to 21L and 11 intermediate layers 31A to 31K.

The recording layers 21A to 21L and the intermediate layers 31A to 31L are alternately disposed. The guide layer 20 and the recording layer 21 are formed in the order of the guide layer 20 and the recording layer 21 from a side of the substrate 11, and recording and playback laser beams 15 and 16 emitted from the optical pickup are incident to the optical disk 10 from an opposite side of the substrate 11. A cover layer 12 is formed on the side of the recording layer 21 that is opposite the substrate 11.

For example, the guide groove or the pit string on the guide layer 20 includes a spiral structure having a depth of 60 nm and a track pitch of 0.64 μm, and a ratio of a recess and a projection in section is substantially 1:1. There is no limitation to the groove depth (the pit depth) or the track pitch. For example, a deep groove (deep pit) having a depth of about 100 nm may be formed, or a shallow groove (shallow pit) having a depth of about 20 nm may be formed. For example, the groove (the pit) having the narrow track pitch of about 0.32 μm or the wide track pitch of about 0.74 μm or about 1.2 μm may be formed.

A track structure may be a concentric ring structure, spiral structure, or what is called a single spiral structure in which a recess and projection are switched every turn. For example, address information is applied to the guide groove by wobble. As used herein, “wobble” means meandering in a direction perpendicular to a track extending direction of the guide groove in a plane of the optical disk 10.

An intermediate layer 30 having optical transparency is formed between the guide layer 20 and the recording layer 21A closest to the guide layer 20. On the other hand, each of intermediate layers 31A to 31K having optical transparency are also formed between the recording layers adjacent to each other in the recording layer 21.

The cover layer 12 has optical transparency. For example, the cover layer 12 has a thickness of 53 μm. There is no particular limitation to the cover layer 12 as long as the cover layer 12 is made of a transparent material. Preferably the cover layer 12 is made of synthetic resins, such as polycarbonate and PMMA, or glass. The information is recorded in the recording layer 21. The recording layer 21 is changed by the laser beam emitted from the optical pickup, and a mark corresponding to the information is recorded in the recording layer 21. For example, the recording layer 21 is a phase change recording film including a multilayer film made of a phase change material or a recordable recording film made of organic dye. For example, one recording layer 21 has a thickness of 0.2 μm or less. The recording layer 21 is much smaller than the cover layer 12 and the intermediate layer 31 in thickness.

In recording and playing back the optical disk 10, the guide layer 20 and the recording layer 21 are irradiated with the laser beams 15 and 16, respectively. The laser beams 15 and 16 have different wavelengths because optical paths are easily separated in the optical pickup. For example, the laser beam 15 is a red laser beam, and the laser beam 16 is a blue-violet laser beam.

FIG. 2 schematically illustrates an example of a signal processing system of an information recording and playback apparatus 300 that performs the recording and playback to the optical disk 10 including the above super-multilayer structure. The information recording and playback apparatus 300 mainly includes an interface (IF) 310, a signal processing unit (DSP) 320, laser drivers (LDD1) 330 and (LDD2) 340, an optical pickup head unit (OPU) 200, an RF amplifier IC (RF AMP) 350, a servo controller 360, and a spindle motor 60. The optical disk 10 including the super-multilayer structure is placed on the spindle motor 60.

The interface 310 is a connection module that exchanges a command and data with an external host instrument (not illustrated), and the interface 310 is compatible with a specific standard (for example, SATA).

The signal processing unit 320 transmits and receives the command and the data to and from the external host instrument through the interface 310, converts the data, transmits a data pulse or a control signal to the laser drivers 330 and 340, transmits a control signal to the servo controller 360, and receives a data signal from the RF amplifier IC 350.

The laser drivers 330 and 340 receive the data pulse or the control signal from the signal processing unit 320, perform conversion into a driving pulse, and transmit the driving pulse to the optical pickup head unit 200.

The optical pickup head unit 200 irradiates the guide layer 20 and recording layer 21 of the optical disk 10 with the laser beams 15 and 16 according to the driving pulse from the laser drivers 330 and 340, receives light reflected from the guide layer 20 and the recording layer 21, and transmits a signal corresponding to a change in intensity of the reflected light to the RF amplifier IC 350.

The RF amplifier IC 350 amplifies the signal from the optical pickup head unit 200 to generate a servo signal and the data signal, and the RF amplifier IC 350 transmits the servo signal and the data signal to the servo controller 360 and the signal processing unit 320, respectively.

The servo controller 360 receives the servo signal from the RF amplifier IC 350, converts the servo signal into an actuator driving signal and a spindle motor driving signal, transmits the actuator driving signal to the optical pickup head unit 200, and transmits the drive signal to the spindle motor 60.

The spindle motor 60 receives the spindle motor driving signal from the servo controller 360, and rotates the placed optical disk 10 about an axis perpendicular to the extending direction of the optical disk 10.

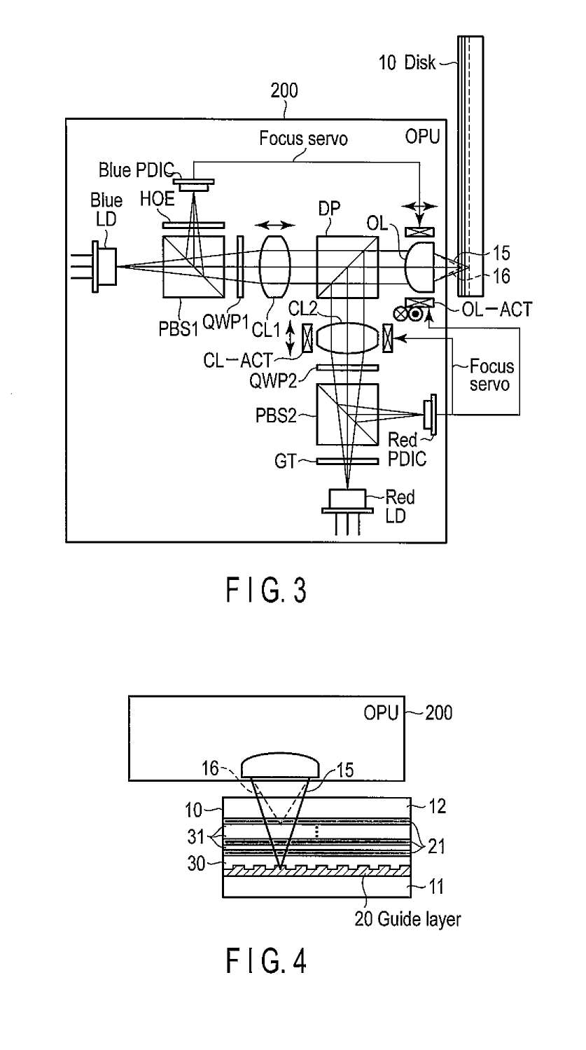

FIG. 3 illustrates an example of an optical system of the optical pickup head unit 200 used in the information recording and playback apparatus 300. The optical pickup head unit (OPU) 200 mainly includes a blue-violet laser (Blue LD), a red laser (Red LD), polarization beam splitters (PBS1 and PBS2), quarter-wave plates (QWP1 and QWP2), collimator lenses (CL1 and CL2), an objective lens (OL), a hologram element (HOE), a blue-violet photodetector IC (Blue PDIC), a red photodetector IC (Red PDIC), a diffraction element (GT), a dichroic prism (DP), a collimator lens actuator (CL-ACT), and an objective lens actuator (OL-ACT).

For example, the blue-violet laser (Blue LD) is a semiconductor laser having a wavelength of 405 nm, and emits a recording and playback laser beam. The blue-violet laser is controlled by the laser driver 340 of the information recording and playback apparatus 300 in FIG. 2.

The polarization beam splitter (PBS1) transmits incident light from the blue-violet laser, and the polarization beam splitter (PBS1) reflects the reflected light of the blue-violet laser from the optical disk 10, in which is a polarization plane rotated by 90 degrees with respect to the incident light.

The quarter-wave plate (QWP1) transmits the incident light from the blue-violet laser, and converts linear polarization into circular polarization. The quarter-wave plate (QWP1) transmits the reflected light of the blue-violet laser from the optical disk 10, and converts the circular polarization into the linear polarization. At this point, the reflected light has the linear polarization in which the polarization plane differs from that of the incident light by 90 degrees. For example, when the incident light has P-polarization, the reflected light has S-polarization.

The collimator lens (CL1) converts the incident light from the blue-violet laser into substantially parallel light.

The objective lens (OL) focuses the light emitted from the blue-violet laser on the recording layer 21 of the optical disk 10. The objective lens includes a wavelength selectivity aperture on a laser beam source side, whereby the red laser beam 15 differs from the blue-violet laser beam 16 in numerical aperture. For example, the objective lens has a numerical aperture of 0.85 for the blue-violet laser beam 16, and has a numerical aperture of 0.65 for the red laser beam 15.

The dichroic prism (DP) transmits the incident light from the blue-violet laser, and reflects the incident light from the red laser.

For example, the red laser (Red LD) is a semiconductor laser having a wavelength of 655 nm, and emits a tracking servo laser beam. The red laser is controlled by the laser driver 330 of the information recording and playback apparatus 300.

The diffraction element (GT) divides the red laser beam 15 into three beams by diffraction. The three beams become one main beam and two sub-beams on the optical disk 10.

The polarization beam splitter (PBS2) transmits incident light from the red laser, and the polarization beam splitter (PBS2) reflects the reflected light of the red laser from the optical disk 10, in which is a polarization plane rotated by 90 degrees with respect to the incident light.

The quarter-wave plate (QWP2) transmits the incident light from the red laser, and converts the linear polarization into the circular polarization. The quarter-wave plate (QWP2) transmits the reflected light of the red laser from the optical disk 10, and converts the circular polarization into the linear polarization. At this point, the reflected light has the linear polarization in which the polarization plane differs from that of the incident light by 90 degrees. For example, when the incident light has P-polarization, the reflected light has S-polarization.

The collimator lens (CL2) converts the incident light from the red laser into substantially parallel light.

The hologram element (HOE) outputs the blue-violet laser, transmits a luminous flux reflected from the recording layer 21 of the optical disk 10, and diffracts a predetermined region of the luminous flux with a predetermined angle.

The blue-violet photodetector IC (Blue PDIC) receives the blue-violet laser beam from the HOE, generates a current according to a light receiving amount, converts the current into a voltage using a current-voltage conversion circuit therein, and outputs the voltage.

The red photodetector IC (Red PDIC) receives the red laser beam reflected from the PBS2, generates the current according to the light receiving amount, converts the current into the voltage using a current-voltage conversion circuit therein, and outputs the voltage.

The collimator lens actuator (CL-ACT) drives the collimator lens (CL2) in a vertical direction in a paper surface such that the red laser beam 15 emitted from the objective lens moves in the optical axis direction (a focus direction) on the optical disk 10.

The objective lens actuator (OL-ACT) drives the objective lens in a crosswise direction in the paper surface such that the laser beam output from the objective lens moves in the optical axis direction (the focus direction) on the optical disk 10. The objective lens actuator (OL-ACT) also drives the objective lens in the direction perpendicular to the paper surface such that the laser beam output from the objective lens moves in the direction (a radial direction) perpendicular to a recording track on the optical disk 10.

An operation of the information recording and playback apparatus 300 in recording the information will be described below with reference to FIGS. 2 and 4. The external host instrument (not illustrated) transmits a user data recording command and recording target data, and the user data recording command and the recording target data are transmitted to the signal processing unit 320 through the interface 310. Therefore, the signal processing unit 320 starts a data recording process according to the received user data recording command.

The signal processing unit 320 transmits the driving signal to the laser drivers 330 and 340, and turns on the red laser (Red LD) and the blue-violet laser (Blue LD) with playback power. The servo controller 360 transmits the spindle motor driving signal to the spindle motor 60, and rotates the optical disk 10 at a predetermined rotation speed.

The signal processing unit 320 transmits a focus search control signal to the servo controller 360. In response to the input focus search control signal, the servo controller 360 performs simple harmonic vibration to the collimator lens (CL2) in the focus direction using the collimator lens actuator (CL-ACT). Therefore, a focal point of the red laser beam 15, which passes through the collimator lens (CL2) to which the simple harmonic vibration is performed and is output from the objective lens (OL), is repeatedly reciprocated in the vertical direction in relation to the guide layer 20 of the optical disk 10.

The light of the red laser beam 15 reflected from the guide layer 20 is focused on the red photodetector IC (Red FDIC). The red photodetector IC (Red FDIC) converts the current based on the reflected light amount into a voltage, and transmits the voltage to the RF amplifier IC 350. The RF amplifier IC 350 generates a focus error signal of the red laser beam 15 from the received voltage signal through a predetermined calculation, and transmits the focus error signal to the servo controller 360. For example, an astigmatism generating optical element (not illustrated) generates the focus error signal by a well-known astigmatism method.

Then, near the focus error signal of zero, the servo controller 360 switches the simple harmonic vibration of the collimator lens (CL2) with the collimator lens actuator (CL-ACT) to driving based on the focus error signal, and the servo controller 360 draws the focus of the red laser beam 15 into the guide groove of the guide layer 20.

Then, the servo controller 360 draws the focus of the blue-violet laser beam 16 into the intended recording layer 21 on the optical disk 10. At this point, the objective lens actuator (OL-ACT) is driven to control the objective lens (OL) in the focus direction based on the focus error signal that the RF amplifier IC 350 generates from the voltage signal transmitted from the blue-violet photodetector IC (Blue PDIC), whereby the focus of the blue-violet laser beam 16 is drawn into the intended recording layer 21.

After the focuses of all the beams are drawn, the servo controller 360 draws the red laser beam 15 into the track formed by the guide groove on the guide layer 20 of the optical disk 10. At this point, the objective lens actuator (OL-ACT) is driven to control the objective lens (OL) in the tracking direction based on a tracking error signal that the RF amplifier IC 350 generates from the voltage signal transmitted from the red photodetector IC (Red PDIC), whereby the servo controller 360 draws the red laser beam 15 into the track on the guide layer 20. For example, the tracking error signal is generated by a well-known differential push-pull method.

Then, the signal processing unit 320 reads the data signal generated by the RF amplifier IC 350 based on the voltage signal transmitted from the red photodetector IC (Red PDIC), thereby playing back a current address.

In the case that the current address differs from the intended address, the signal processing unit 320 transmits a track jump control signal, which is the number of tracks corresponding to a difference between the current address and the intended address, to the servo controller 360. Based on the input track jump control signal, the servo controller 360 transmits the driving pulse to the objective lens actuator (OL-ACT) to move the red laser beam 15 to the desired track. At this point, the blue-violet laser beam 16 with which the optical disk 10 is irradiated through the same objective lens (OL) performs the same track movement.

When checking that the red laser beam 15 reaches the intended address, the signal processing unit 320 transmits a recording data series to the laser driver 340. The laser driver 340 generates the driving pulse according to the received recording data series, and transmits the driving pulse to the blue-violet laser (Blue LD) to perform the pulse driving of the blue-violet laser (Blue LD). Therefore, the blue-violet laser beam 16 emitted from the blue-violet laser is focused on the intended recording layer 21 of the optical disk 10 through the objective lens (OL), and a recording mark is formed according to the recording data series. Thus, the recording target data is recorded in the intended recording layer 21 of the optical disk 10.

An operation of the information recording and playback apparatus 300 in playing back the information will be described below with reference to FIG. 2. The external host instrument (not illustrated) transmits a user data playback command, and the user data playback command is transmitted to the signal processing unit 320 through the interface 310. Therefore, the signal processing unit 320 starts a data playback process according to the received user data playback command.

The signal processing unit 320 transmits the driving signal to the laser drivers 330 and 340, and turns on the red laser (Red LD) and the blue-violet laser (Blue LD) with playback power. The servo controller 360 transmits the spindle motor driving signal to the spindle motor 60, and rotates the optical disk 10 at a predetermined rotation speed.

The signal processing unit 320 transmits the focus search control signal to the servo controller 360. In response to the input focus search control signal, the servo controller 360 performs the simple harmonic vibration to the collimator lens (CL2) in the focus direction using the collimator lens actuator (CL-ACT). Therefore, the focal point of the red laser beam 15, which passes through the collimator lens (CL2) to which the simple harmonic vibration is performed and is output from the objective lens (OL), is repeatedly reciprocated in the vertical direction in relation to the guide layer 20 of the optical disk 10.

The light of the red laser beam 15 reflected from the guide layer 20 is focused on the red photodetector IC (Red PDIC). The red photodetector IC (Red PDIC) converts the current based on the reflected light amount into the voltage, and transmits the voltage to the RF amplifier IC 350. The RF amplifier IC 350 generates the focus error signal of the red laser beam 15 from the received voltage signal through the predetermined calculation, and transmits the focus error signal to the servo controller 360.

Then, when the focus error signal is nearly zero, the servo controller 360 switches the simple harmonic vibration of the collimator lens (CL2) with the collimator lens actuator (CL-ACT) to driving based on the focus error signal, and the servo controller 360 draws the focus of the red laser beam 15 into the guide groove of the guide layer 20.

Then, the servo controller 360 draws the focus of the blue-violet laser beam 16 into the intended recording layer 21 on the optical disk 10. At this point, the objective lens actuator (OL-ACT) is driven to control the objective lens (OL) in the focus direction based on the focus error signal that the RF amplifier IC 350 generates from the voltage signal transmitted from the blue-violet photodetector IC (Blue PDIC), whereby the focus of the blue-violet laser beam 16 is drawn into the intended recording layer 21.

After the focuses of all the beams are drawn, the servo controller 360 draws the red laser beam 15 into the track formed by the guide groove on the guide layer 20 of the optical disk 10. At this point, the objective lens actuator (OL-ACT) is driven to control the objective lens (OL) in the tracking direction based on the tracking error signal that the RF amplifier IC 350 generates from the voltage signal transmitted from the red photodetector IC (Red PDIC), whereby the servo controller 360 draws the red laser beam 15 into the track on the guide layer 20.

Then, the signal processing unit 320 reads the data signal generated by the RF amplifier IC 350 based on the voltage signal transmitted from the red photodetector IC (Red PDIC), thereby playing back a current address.

In the case that the current address differs from the intended address, the signal processing unit 320 transmits a track jump control signal, which is the number of tracks corresponding to a difference between the current address and the intended address, to the servo controller 360. Based on the input track jump control signal, the servo controller 360 transmits the driving pulse to the objective lens actuator (OL-ACT) to move the red laser beam 15 to the desired track. At this point, the blue-violet laser beam 16 with which the optical disk 10 is irradiated through the same objective lens (OL) performs the same track movement.

The blue-violet photodetector IC (Blue PDIC) converts the current, which is based on the amount of light of the blue-violet laser beam 16 reflected from the recording layer 21 of the optical disk 10, into the voltage, and the blue-violet photodetector IC (Blue PDIC) transmits the voltage to the RF amplifier IC 350. The RF amplifier IC 350 generates the tracking error signal of the blue-violet laser beam 16 from the received voltage signal through the predetermined calculation, and transmits the tracking error signal to the servo controller 360. In this case, for example, the tracking error signal is a Differential Phase Detection (DPD) signal or a push-pull signal, which is generated from a recorded mark string of the recording layer 21.

After determining that the red laser beam 15 reaches the track near the intended address, the signal processing unit 320 transmits a control signal to the servo controller 360 in order to separate the servo controller 360 from the tracking servo of the guide layer 20 with the red laser beam 15. Therefore, the servo controller 360 switches the driving of the objective lens actuator (OL-ACT) from the driving based on the tracking error signal of the red laser beam 15 to the driving based on the tracking error signal of the blue-violet laser beam 16, and draws the blue-violet laser beam 16 into the recorded track of the recording layer 21.

Then, the signal processing unit 320 reads the data signal generated by the RF amplifier IC 350 based on the voltage signal transmitted from the blue-violet photodetector IC (Blue PDIC), thereby playing back the current address of the recording layer 21 into which the blue-violet laser beam 16 is drawn.

In the case that the current address differs from the intended address, the signal processing unit 320 transmits the track jump control signal, which is the number of tracks corresponding to the difference between the current address and the intended address, to the servo controller 360. Based on the input track jump control signal, the servo controller 360 transmits the driving pulse to the objective lens actuator (OL-ACT) to move the blue-violet laser beam 16 to the desired track.

When checking that the blue-violet laser beam 16 reaches the intended address, the signal processing unit 320 starts the data playback from the recording layer 21. Thus, the information can be played back from the intended recording layer 21.

As described above, the red laser beam 15 used to play back the information from the guide layer 20 and the blue-violet laser beam 16 used to record in the recording layer 21 or to play back the information from the recording layer 21 play necessary roles, respectively, thereby implementing the recording and playback of the information in and from the optical disk 10.

As described above, in the information recording and playback apparatus 300 that performs the recording and playback to the super-multilayer-structure optical disk 10, which includes the guide layer 20 independently of the plural recording layers 21, it is necessary to use the two kinds of laser beams, namely, the laser beam (in the embodiment, the red laser beam 15) with which the guide layer 20 of the optical disk 10 is irradiated and the laser beam (in the embodiment, the blue-violet laser beam 16) with which the intended recording layer 21 of the optical disk 10 is irradiated.

Therefore, it is necessary to focus the red laser beam 15 on the guide layer 20 of the optical disk 10, namely, it is necessary to draw the focus of the red laser beam 15 into the guide layer 20, and it is necessary to focus the blue-violet laser beam 16 on the intended recording layer 21 of the optical disk 10, namely, it is necessary to draw the focus of the blue-violet laser beam 16 into the intended recording layer 21.

In this case, the focus of the blue-violet laser beam 16 is drawn into the recording layer 21 by controlling the objective lens (OL) in the focus direction using the objective lens actuator (OL-ACT). The focus of the red laser beam 15 is drawn into the guide layer 20 by controlling the collimator lens (CL2) in the focus direction (the optical axis direction) using the collimator lens actuator (CL-ACT).

In order that the red laser beam 15 is focused on the guide layer 20 of the optical disk 10 while the blue-violet laser beam 16 is focused on the intended recording layer 21 of the optical disk 10, it is necessary to place the two optical paths, namely, the optical path for the red laser beam 15 and the optical path for the blue-violet laser beam 16 in the optical pickup head unit 200. For this reason, the structure of the optical pickup head unit 200 becomes more complex, which results in the enlargement of the optical pickup head unit 200 and therefore the information recording and playback apparatus 300.

Particularly, it is necessary to perform the focus servo to the collimator lens (CL2) so as to draw the focus of the red laser beam 15 into the guide layer 20 of the optical disk 10. Therefore, the collimator lens actuator (CL-ACT) is required to be able to drive the collimator lens (CL2) at high speed in the optical axis direction of the collimator lens (CL2).

In the embodiment, a lens actuator including a simple structure, in which the lens can be driven at high speed in the optical axis direction of the lens while downsizing is achieved, will be described. For example, the lens actuator of the embodiment is suitably used in the collimator lens actuator (CL-ACT) that drives the collimator lens (CL2) transmitting the red laser beam 15 in the focus direction (the optical axis direction), and the lens actuator includes the structure contributing to the downsizing of the optical pickup head unit 200.

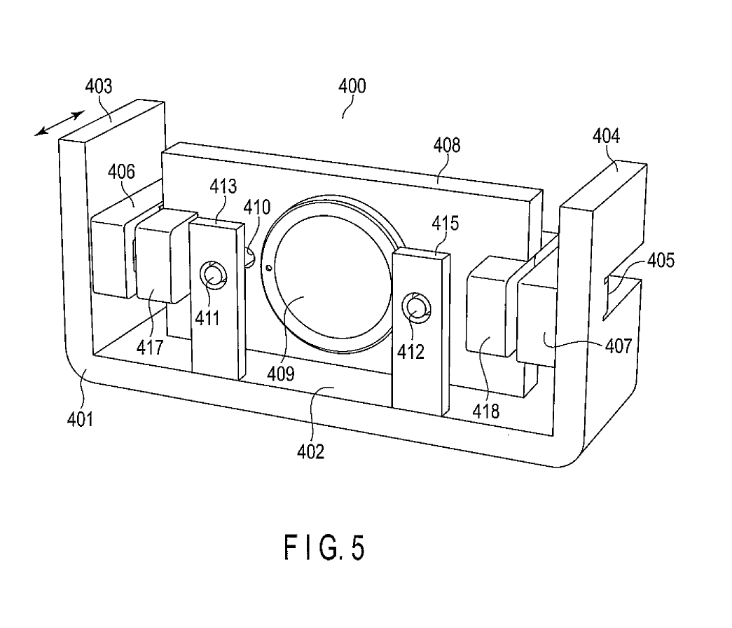

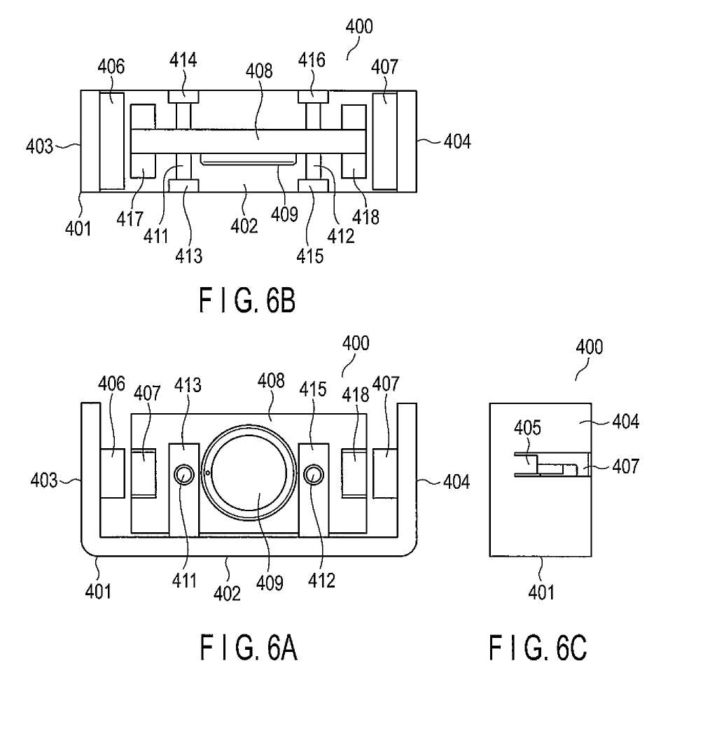

FIG. 5 illustrates an example of an appearance of a lens actuator 400 of the embodiment. FIGS. 6A, 6B, and 6C illustrate an example of the lens actuator 400 when the lens actuator 400 is viewed from a front side, an upper side, and a side surface.

The lens actuator 400 includes a coil supporting member 401 that is of the fixed member. The coil supporting member 401 made of a magnetic material is formed into a substantially rectangular shape, and a central portion of the coil supporting member 401 constitutes a bottom surface 402 and is fixed to the inside of the optical pickup head unit 200. In this case, the coil supporting member 401 is placed such that the bottom surface 402 is substantially parallel to the surface of the optical disk 10 rotated by the spindle motor 60 (for example, the coil supporting member 401 is horizontally placed).

In the coil supporting member 401, a pair of side surfaces 403 and 404 are formed by bending both end portions in a lengthwise direction of the coil supporting member 401 at a substantially right angle with respect to the bottom surface 402 such that the end portions face each other. Each of the side surfaces 403 and 404 is partially notched and bend inside, thereby forming latch parts 405 (a latch part of the side surface 403 is not seen in the drawings) that are projected toward the insides of the side surfaces 403 and 404.

In the coil supporting member 401, coils 406 and 407 are placed in inside surfaces of the pair of side surfaces 403 and 404, namely, the surfaces facing each other, respectively. The coils 406 and 407 are fixed using the latch parts 405 that are projected toward the insides of the side surfaces 403 and 404 constituting the coil supporting member 401.

The coil supporting member 401 supports a lens holder 408 at a position surrounded by the bottom surface 402 and the pair of side surfaces 403 and 404. For example, the lens holder 408 made of a synthetic resin material is formed into the substantially rectangular shape, and a lens 409 is retained in the central portion of the lens holder 408.

The lens holder 408 is placed in the direction perpendicular to the bottom surface 402 and the pair of side surfaces 403 and 404, which constitute the coil supporting member 401, such that the optical axis of the lens 409 is aligned with a width direction of the coil supporting member 401, namely, an arrow direction in FIG. 5.

Circular through-holes 410 (one of through-holes is not seen in the drawings) are made in the lens holder 408 at two positions, which are parallel to the bottom surface 402 constituting the coil supporting member 401 and symmetrical with respect to the optical axis of the lens 409. Guide shafts 411 and 412 formed into substantially cylindrical shapes are inserted in the through-holes 410 in parallel with each other so as to be able to slide in the optical axis direction of the lens 409.

Both end portions of the guide shaft 411 are fixed to a pair of guide support parts 413 and 414. The guide support parts 413 and 414 are formed on both sides in the width direction of the bottom surface 402 constituting the coil supporting member 401, and raised perpendicularly to the bottom surface 402 so as to face each other. Both end portions of the guide shaft 412 are fixed to a pair of guide support parts 415 and 416. The guide support parts 415 and 416 are formed on both the sides in the width direction of the bottom surface 402 constituting the coil supporting member 401, and raised perpendicularly to the bottom surface 402 so as to face each other.

Therefore, the lens holder 408 is movably supported in the optical axis direction of the lens 409, namely, the direction substantially parallel to the surface of the optical disk 10 rotated by the spindle motor 60 with respect to the coil supporting member 401.

In the lens holder 408, magnets 417 and 418 are attached to both end portions that face the coils 406 and 407, respectively. In each of the magnets 417 and 418, an N-pole is formed on one side of the central portion in the optical axis direction of the lens 409, and an S-pole is formed on the other side. The magnets 417 and 418 are placed such that portions having different polarities face each other. Therefore, a magnetic field is generated between the magnets 417 and 418, and a magnetic circuit is formed together with the coil supporting member 401.

When the current is passed through the coils 406 and 407, the lens holder 408 and therefore the lens 409 can be driven in the optical axis direction by interaction of the magnets 417 and 418 with the magnetic circuit. A driving direction or a movement amount of the lens 409 can be controlled by adjusting the direction or magnitude of the current passed through the coils 406 and 407.

In the lens actuator 400, the pair of guide shafts 411 and 412 are placed along the optical axis direction of the lens 409 in the coil supporting member 401 that is of the fixed member, and the lens holder 408 is inserted in the guide shafts 411 and 412, whereby the lens 409 is supported so as to be movable in the optical axis direction. Therefore, in the lens actuator 400, the downsizing can be achieved by an extremely simple configuration while a driving distance necessary for the lens 409 is ensured.

In the embodiment, the lens 409 and the lens holder 408 are separately provided. Alternatively, for example, the lens 409 and the lens holder 408 may integrally be formed using the same material as the lens 409.

In the lens actuator 400, the two cylindrical guide shafts 411 and 412 placed in the coil supporting member 401 are inserted in the two circular through-holes 410 made in the lens holder 408. Alternatively, for example, one quadrangular guide shaft placed in the coil supporting member 401 may be inserted in one quadrangular through-hole made in the lens holder 408.

The lens actuator 400 has a simple configuration, in which the guide shafts 411 and 412 placed on the coil supporting member 401 along the optical axis direction of the lens 409 are inserted in the lens holder 408 and the lens 409 is driven in the optical axis direction by the interaction between the coils 406 and 407 of the coil supporting member 401 and the magnets 417 and 418 of the lens holder 408, which allows the lens 409 to be driven at high speed in the optical axis direction.

Therefore, like the information recording and playback apparatus 300, the collimator lens actuator (CL-ACT) that drives the collimator lens (CL2) in the focus direction (the optical axis direction) is suitably used in order to draw the focus of the red laser beam 15 into the guide layer 20 of the optical disk 10, namely, in order for the focus servo to focus the red laser beam 15.

At this point, what is commonly called a rack-and-pinion mechanism is generally used as means for driving the collimator lens in the optical axis direction. In the rack-and-pinion mechanism, a worm gear is engaged with a linear gear formed in the lens holder in the optical axis direction of the lens, and the worm gear is normally or reversely rotated by a motor, thereby driving the lens in the optical axis direction.

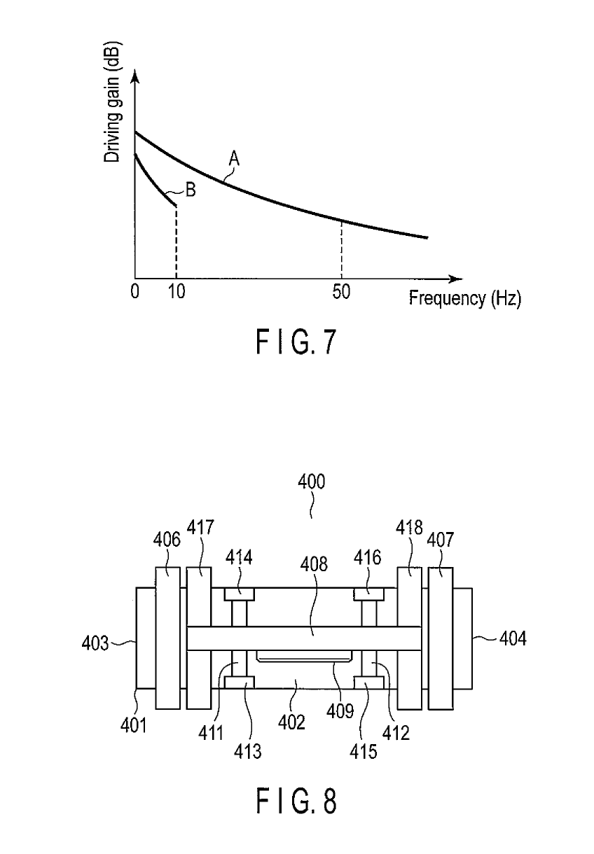

In FIG. 7, a characteristic curve A illustrates an example of a relationship between a driving frequency and a driving gain of the lens 409 in the lens actuator 400 of the embodiment, and a characteristic curve B illustrates an example of a relationship between a driving frequency and a driving gain of a lens in the rack-and-pinion mechanism.

As is clear from the characteristic curve B, in the rack-and-pinion mechanism, the driving gain cannot be obtained when the driving frequency of the lens is greater than or equal to 10 Hz; namely, the lens cannot be driven at frequencies (speeds) of 10 Hz or more. Therefore, the rack-and-pinion mechanism cannot be used in the focus servo of the collimator lens (CL2).

On the other hand, in the lens actuator 400 of the embodiment, as illustrated in the characteristic curve A, the driving gain can be obtained even if the driving frequency of the lens 409 is greater than 10 Hz. In the lens actuator 400 of the embodiment, as is clear from the characteristic curve A, the lens 409 can be driven at frequencies of 50 Hz or more. Therefore, the lens actuator 400 has a performance sufficient to act as a focus servo for the collimator lens (CL2).

FIG. 8 illustrates a modification of the lens actuator 400. The modification differs from the lens actuator 400 in FIG. 5 in that the coils 406 and 407 and the magnets 417 and 418 are placed so as to be projected outward from both the end portions in the width direction of the coil supporting member 401.

In the configuration of the modification, the coils 406 and 407 and the magnets 417 and 418 face each other even if the lens 409 is located at any position within the driving range, so that the stable driving force can always be obtained while the downsizing is achieved. That is, the coil supporting member 401 is opened in the width direction, namely, in the optical axis direction of the lens 409, so that at least one of the coils 406 and 407 and the magnets 417 and 418 can be placed so as to be projected from both the end portions in the width direction of the coil supporting member 401.

In the embodiment, the lens actuator 400 drives the collimator lens (CL2), which controls the red laser beam 15 with which the guide layer 20 of the optical disk 10 is irradiated, in the optical axis direction. Additionally, the lens actuator 400 can also be used to drive the collimator lens (CL1), which controls the blue-violet laser beam 16 with which the recording layer 21 of the optical disk 10 is irradiated, in the optical axis direction.

Not only can the lens actuator 400 be used in the optical pickup head unit 200 of the information recording and playback apparatus 300, but also, the lens actuator 400 can be widely used to drive the lens in various electronic instruments that include such lenses.

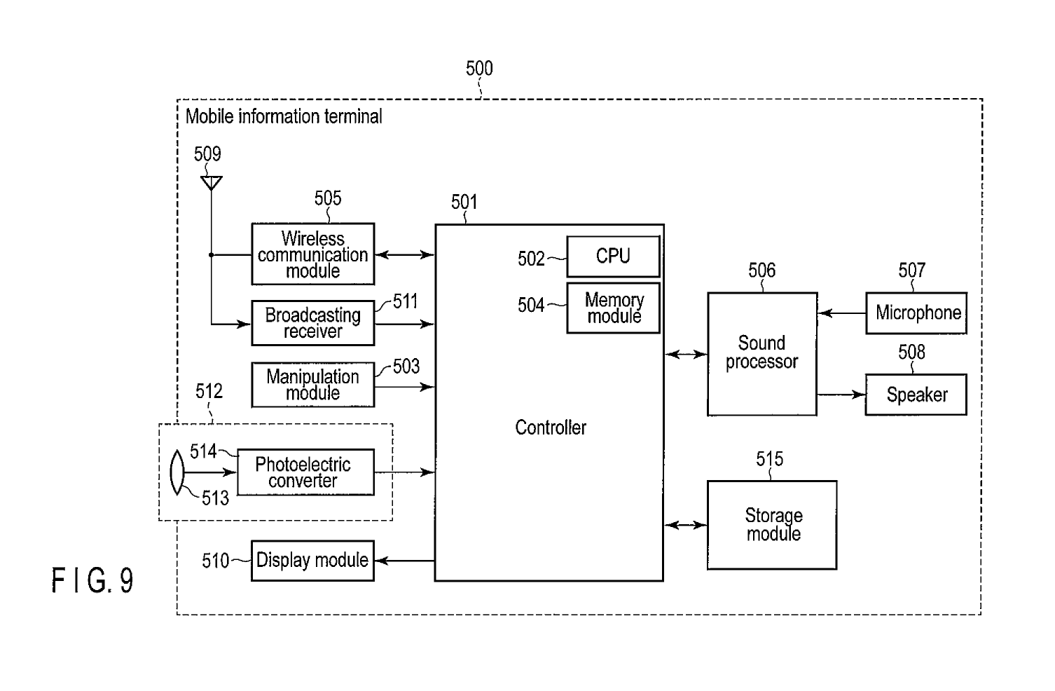

FIG. 9 schematically illustrates an example of a signal processing system of a mobile information terminal 500 that is of the electronic instrument. The mobile information terminal 500 includes a controller 501 that controls all the operations of the mobile information terminal 500. For example, the controller 501 is provided with a CPU 502. The controller 501 receives manipulation information from a manipulation module 503, and controls each part such that manipulation content of the part is reflected.

In this case, the controller 501 uses a memory module 504. The memory module 504 mainly includes a read only memory (ROM) in which a control program executed by the CPU 502 is stored, a random access memory (RAM) that provides a work area to the CPU 502, and a nonvolatile memory in which various pieces of setting information and control information are stored.

A wireless communication module 505 and a sound processor 506 are connected to the controller 501. A microphone 507 and a speaker 508 are connected to the sound processor 506. The controller 501 transmits a sound signal, which is collected by the microphone 507 and supplied through the sound processor 506, from an antenna 509 through the wireless communication module 505. The controller 501 supplies a signal, which is received by the antenna 509 and supplied through the wireless communication module 505, to the speaker 508 through the sound processor 506, and plays back the signal as the sound signal. Therefore, the controller 501 implements a telephone function.

The controller 501 controls transmission and reception of an electronic mail through the wireless communication module 505 and the antenna 509. In this case, the controller 501 causes a display module 510 to display a sentence of the transmitted and received electronic mail.

The controller 501 accesses a server (not illustrated), which is connected to a network, such as the Internet, through the wireless communication module 505 and the antenna 509, and the controller 501 can acquire necessary information from the server by wireless communication.

A broadcasting receiver 511 may be connected to the controller 501. The broadcasting receiver 511 tunes and demodulates a broadcasting signal of a desired channel from broadcasting signals received through the antenna 509, generates a video signal and a sound signal, and supplies the video signal and the sound signal to the controller 501. Therefore, the controller 501 causes the display module 510 to display a video picture based on the video signal, and causes the speaker 508 to play back a sound based on the sound signal, thereby implementing a broadcasting receiving function.

An imaging module 512 is connected to the controller 501. In the imaging module 512, a photoelectric converter 514 converts an optical image of a subject incident through an imaging lens 513 into a video signal, and the video signal is supplied to the controller 501. The controller 501 stores the video signal supplied from the imaging module 512 in a storage module 515, thereby implementing a camera function.

The controller 501 also includes a function of reading the video signal or sound signal of copyright protected content that is stored in an external storage device (not illustrated) detachably attached to the mobile information terminal 500.

The controller 501 can store various video signals and sound signals, which are transmitted and received by the telephone function, the electronic mail function, the broadcasting receiving function, the camera function, and the network access function, in the storage module 515.

The lens actuator 400 can be used to support the imaging lens 513 constituting the imaging module 512 of the mobile information terminal 500.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lens driving device comprising:
a fixed member;
a movable member configured to retain a lens and a magnet;
a support part configured to support the movable member at a plurality of positions that are symmetric with respect to an optical axis of the lens such that the movable member is configured to move in an optical axis direction of the lens with respect to the fixed member using a guide member substantially in parallel with the optical axis of the lens; and
a coil configured to generate a driving force for the movable member by interaction with the magnet in the fixed member.

2. The lens driving device of claim 1, wherein the support part is configured to support the movable member such that the movable member is configured to move in the optical axis direction of the lens with respect to the fixed member by inserting a plurality of guide shafts in each of the movable members, the guide shafts being placed substantially in parallel with the optical axis of the lens at the positions that are symmetric with respect to an optical axis of the lens.

3. The lens driving device of claim 1, wherein
the fixed member comprises a structure in which the optical axis direction of the lens is opened, and
at least the magnet or the coil is projected toward the optical axis direction of the lens with respect to the fixed member.

4. An electronic instrument comprising:
a lens configured to be driven in an optical axis direction by the lens driving device of claim 1.

5. An information recording and playback apparatus comprising:
a lens driver, the lens driver comprising: a fixed member; a movable member configured to retain a lens and a magnet; a support part configured to support the movable member at a plurality of positions that are symmetric with respect to an optical axis of the lens such that the movable member is configured to move in an optical axis direction of the lens with respect to the fixed member using a guide member substantially in parallel with the optical axis of the lens; and a coil configured to generate a driving force for the movable member by interaction with the magnet in the fixed member,
wherein information is recorded in and played back from an information recording medium by irradiating the information recording medium with a laser beam through the lens driven in the optical axis direction by the lens driver.

6. The information recording and playback apparatus of claim 5, wherein the information recording medium is an optical disk comprising a plurality of recording layers and a guide layer.

7. The information recording and playback apparatus of claim 6, wherein the lens driven in the optical axis direction by the lens driver is configured to control a laser beam with which the guide layer of the optical disk is irradiated.

8. The information recording and playback apparatus of claim 6, wherein the lens driven in the optical axis direction by the lens driver is configured to control a laser beam with which the recording layer of the optical disk is irradiated.

9. The information recording and playback apparatus of claim 5, wherein the lens driven in the optical axis direction by the lens driver is a collimator lens.

10. An information recording and playback apparatus comprising:
a lens driver configured to be able to drive a lens at frequencies higher than 10 Hz in an optical axis direction of the lens, the lens being on an optical path between a light source and an objective lens, an optical disk being irradiated with light emitted from the light source through the objective lens,
wherein information is recorded in and played back from the optical disk by irradiating the optical disk with the light through the lens driven in an optical axis direction by the lens driver.
